(19) United States
(12) Patent Application Publication
(10) Pub. No.: US 2017/0256214 A1
(43) Pub. Date: Sep. 7, 2017

(54) DISPLAY DEVICE

(71) Applicant: Panasonic Liquid Crystal Display Co., Ltd., Hyogo (JP)

(72) Inventor: Yuuya SATOU, Hyogo (JP)

(21) Appl. No.: 15/059,312

(22) Filed: Mar. 3, 2016

(51) Int. Cl. G09G 3/36

(52) U.S. Cl. CPC G09G 3/3648; G09G 2330/022; G09G 2310/0245; G09G 2310/061

(57) ABSTRACT

Provided is a display device, including: a display panel configured to display an image; a control unit configured to control the display panel based on input image data input from outside; and a storage unit configured to store predetermined pattern image data, in which the control unit is further configured to determine whether or not the input image data is to be input during a predetermined time period after a supply voltage from a power source has reached a predetermined value, display a pattern image based on the pattern image data on the display panel after the predetermined time period has elapsed when the determination unit determines that the input image data is not to be input, and display an input image based on the input image data on the display panel when the determination unit determines that the input image data is to be input.

### BACKGROUND

1. Technical Field

The present application relates to a display device.

2. Description of the Related Art

In Japanese Patent Application Laid-open No. 2003-114653, there is disclosed a technology for displaying a predetermined pattern image such as a logo of a manufacturer during a waiting time after a display device is powered on until the display device becomes ready to conduct display normally.

### SUMMARY

During an operation of a display device, there may occur a so-called instantaneous interruption which is a phenomenon that voltage supply from a power source is interrupted for a short period of time. In the related art, a distinction between a case where the display device recovers from the instantaneous interruption and a time of power-on is not taken into consideration, and hence a pattern image is displayed when the display device recovers from the instantaneous interruption in the same manner as at the time of power-on.

However, when the display device recovers from the instantaneous interruption, the display device often becomes ready to conduct display normally relatively quickly, and hence the pattern image does not always need to be displayed every time the display device recovers from the instantaneous interruption.

The present application has been made in view of the above-mentioned problem, and provides a display device capable of preventing a pattern image from being displayed every time the display device recovers from an instantaneous interruption.

In order to solve the above-mentioned problem, according to one embodiment of the present application, there is provided a display device, including: a display panel configured to display an image; a control unit configured to control the display panel based on input image data input from outside; and a storage unit configured to store predetermined pattern image data, in which: the control unit includes a determination unit configured to determine whether or not the input image data is to be input during a predetermined time period after a supply voltage from a power source has reached a predetermined value; and the control unit is further configured to display a pattern image based on the predetermined pattern image data on the display panel after the predetermined time period has elapsed when the determination unit determines that the input image data is not to be input, and display an input image based on the input image data on the display panel when the determination unit determines that the input image data is to be input.

In the display device according to the one embodiment of the present application, the storage unit may be further configured to store black image data, and the control unit may be further configured to display a black image based on the black image data on the display panel during the predetermined time period.

In the display device according to the one embodiment of the present application, the determination unit may be further configured to: determine a plurality of times whether or not the input image data has been input during the predetermined time period; and display the input image based on the input image data on the display panel when a number of times that an input of the input image data has been detected exceeds a predetermined number of times.

### BRIEF DESCRIPTION OF THE DRAWINGS

FIG. 1 is a diagram for illustrating an example of a configuration of a display device according to an embodiment of the present application.

FIG. 2 is a graph for showing an example of a time variation of a supply voltage supplied from a power supply circuit to a control unit.

FIG. 3 is a timing chart for illustrating an example of an image display operation of a display device according to a comparative example of the present application.

FIG. 4 is a block diagram for illustrating an example of functions implemented by the control unit according to the embodiment of the present application.

FIG. 5 is a timing chart for illustrating an example of an image display operation of the display device according to the embodiment of the present application.

### DETAILED DESCRIPTION

Now, an embodiment of the present application is described with reference to the accompanying drawings. This embodiment is described by taking a liquid crystal display device as an example, but a display device according to the present application is not limited to the liquid crystal display device, and may be, for example, an organic EL display device. Note that, in the figures, the same components or equivalent components are denoted by the same reference symbols, and duplicate descriptions thereof are omitted.

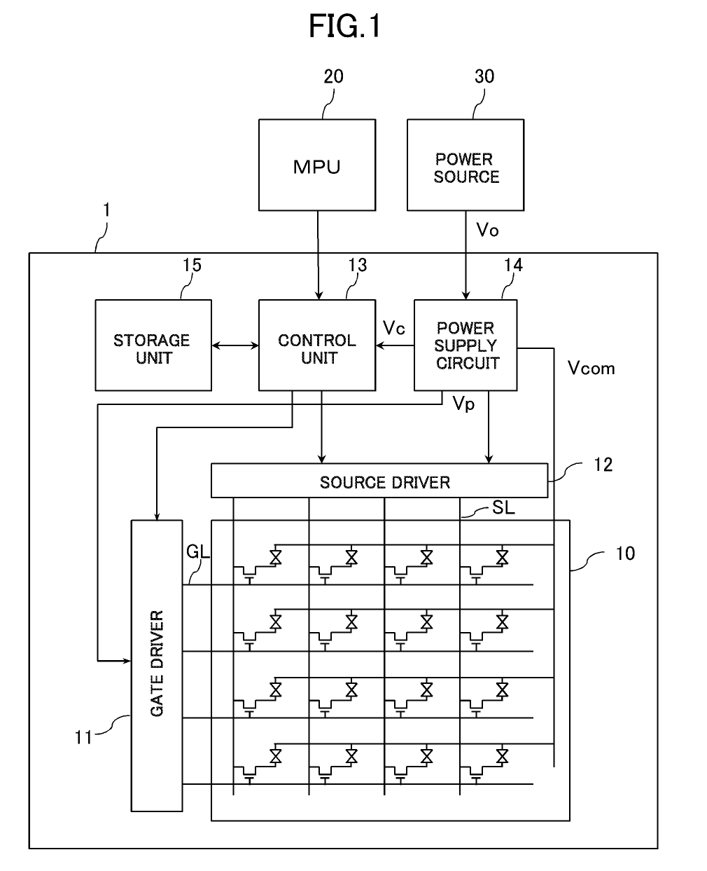

FIG. 1 is a diagram for illustrating an example of a configuration of a display device 1 according to this embodiment. As illustrated in FIG. 1, the display device 1 according to this embodiment includes a display panel 10 configured to display an image, a gate driver 11, a source driver 12, a control unit 13, a power supply circuit 14, and a storage unit 15.

The display panel 10 includes a TFT substrate (not shown), a counter substrate (not shown), and a liquid crystal layer (not shown) sandwiched between the TFT substrate and the counter substrate. A plurality of gate lines GL connected to the gate driver 11 and a plurality of source lines SL connected to the source driver 12 are formed on the TFT substrate, and a thin film transistor is formed in each of intersection parts between the gate lines GL and the source lines SL. Further, in the display panel 10, a plurality of pixels are arrayed in a matrix shape in association with the respective intersection parts. The display panel 10 further includes a pixel electrode formed on the TFT substrate so as to correspond to each pixel and a common electrode formed on the counter substrate. The TFT substrate and the counter substrate may each employ a known configuration.

The gate driver 11 supplies a gate signal to each of the plurality of gate lines GL. The gate driver 11 is arranged on one side-surface side (left side in FIG. 1) of the display panel 10. Note that, the gate driver 11 may be arranged on both side-surface sides (left side and right side in FIG. 1) of the display panel 10.

The source driver 12 supplies a source signal to each of the plurality of source lines SL. The source driver 12 is arranged on one side-surface side (top side in FIG. 1) of the display panel 10. Note that, the source driver 12 may be arranged on both side-surface sides (top side and bottom side in FIG. 1) of the display panel 10.

The control unit 13 generates and outputs an image for display to be displayed on the display panel 10 and a control signal for controlling the gate driver 11 and the source driver 12 based on input image data and timing signals (such as clock signal, vertical synchronizing signal, and horizontal synchronizing signal) that are supplied from a central processing unit (MPU 20) of an external display system.

The power supply circuit 14 supplies various voltages to the respective components of the display panel 10, the gate driver 11, the source driver 12, and the control unit 13. For example, the power supply circuit 14 supplies a supply voltage Vc to the control unit 13 based on a power supply voltage Vo supplied from an external power source 30. Further, the power supply circuit 14 generates a driving voltage Vp for driving the display panel 10 and a common voltage Vcom based on the power supply voltage Vo supplied from the external power source 30. The driving voltage Vp required for driving the display panel 10 is supplied to the gate driver 11 and the source driver 12. Further, the common voltage Vcom is supplied to the common electrode formed on the counter substrate of the display panel 10.

The storage unit 15 includes a memory device such as a RAM or a ROM, and stores a program to be executed by the control unit 13. Further, the storage unit 15 functions as a work memory for the control unit 13.

A brief description is made of a driving method for the display device 1. The gate signal is supplied from the gate driver 11 to the gate line GL. The thin film transistor is turned on or off by the gate signal. On the other hand, the source signal is supplied from the source driver 12 to the source line SL. The common voltage Vcom is supplied to the common electrode. When an on voltage of the gate signal (gate-on voltage) is supplied to the gate line GL, the thin film transistor connected to the gate line GL is turned on, and the source signal is supplied to the pixel electrode through the source line SL connected to the thin film transistor. An electric field is generated due to a difference between a source voltage supplied to the pixel electrode and the common voltage Vcom supplied to the common electrode. Liquid crystal is driven by the electric field to control a transmittance of light from a backlight unit (not shown), to thereby display an image.

Note that, the display panel 10 may be of an in-plane switching (IPS) system, a twisted nematic (TN) system, or a vertical alignment (VA) system.

In this embodiment, the storage unit 15 stores image data (such as pattern image data and black image data) corresponding to the image to be displayed on the display panel 10. The pattern image data is image data corresponding to a logo of a manufacturer or other such predetermined pattern images. The black image data is image data for conducting display in black on the entire display panel 10. In the display device 1 according to this embodiment, a pattern image based on the above-mentioned pattern image data is displayed on the display panel 10 during a time period after the display device 1 starts up (after power-on of the display device 1) until the display device 1 becomes ready to display an input image.

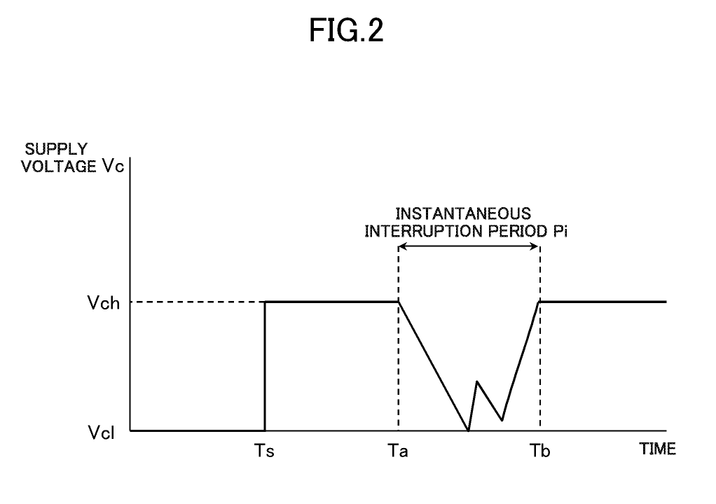

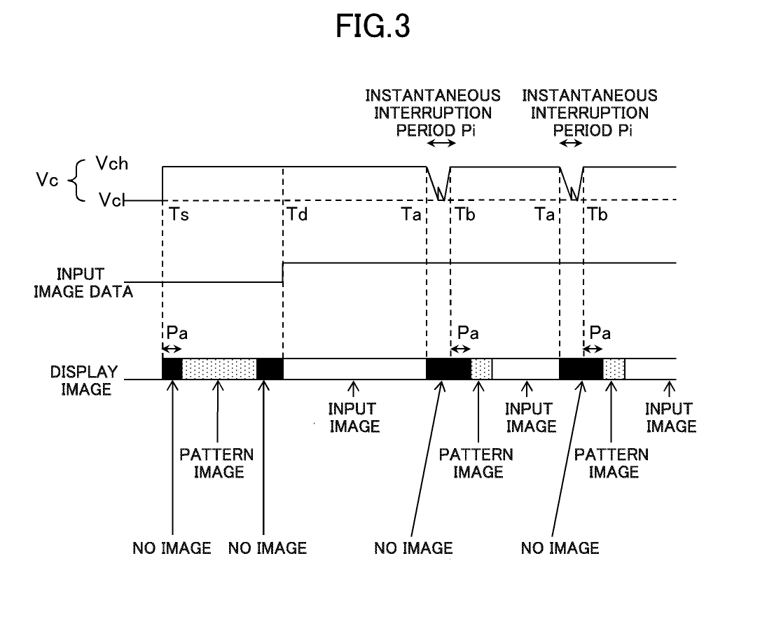

Further, in the display device 1 according to this embodiment, there may occur a so-called “instantaneous interruption” which is a phenomenon that voltage supply from the external power source 30 is interrupted for a short period of time. The instantaneous interruption occurs due to an insufficient power source capacity, a connection failure of a power source cable or a connector, or the like. In addition, in this embodiment, for example, the instantaneous interruption may occur due to the above-mentioned connection failure caused between the external power source 30 and the power supply circuit 14, inside the power supply circuit 14, and between the power supply circuit 14 and the control unit 13, or due to other such factors. When the instantaneous interruption occurs in the display device 1, the display device 1 is temporarily under a state in which an image is not displayed on the display panel 10 until a recovery is made from the instantaneous interruption (until the voltage supply is recovered). In this case, from the viewpoint that the voltage supply from the power source 30 is started, it should be understood that the display device 1 conducts the same operation both when the display device 1 starts up and when the display device 1 recovers from the instantaneous interruption. Therefore, the pattern image may be displayed on the display panel 10 when the display device 1 recovers from the instantaneous interruption in the same manner as when the display device 1 starts up. This operation is described with reference to FIG. 2 and FIG. 3 for showing a comparative example of the present application.

FIG. 2 is a graph for showing an example of a time variation of the supply voltage Vc supplied from the power supply circuit 14 to the control unit 13. As shown in FIG. 2, the display device 1 starts up at a time Ts (hereinafter referred to as “startup time Ts”). While the display device 1 is operating normally, the supply voltage Vc having a predetermined value (Vch) is supplied to the control unit 13. Vch is set as an operable voltage that enables the control unit 13 to operate. When an instantaneous interruption occurs at a time Ta (hereinafter referred to as “instantaneous interruption occurrence time Ta”), the supply voltage Vc decreases to Vcl, and then the supply voltage Vc is recovered to Vch at a time Tb (hereinafter referred to as “instantaneous interruption recovery time Tb”). Vcl maybe set to 0 V, or may be set to a voltage below a minimum voltage (threshold voltage) required by the control unit 13 to operate. In this case, a period from the instantaneous interruption occurrence time Ta until the instantaneous interruption recovery time Tb is set as an instantaneous interruption period Pi. Note that, a time point at which the supply voltage Vc starts to decrease from Vch may be set as a time point of an occurrence of the instantaneous interruption, or a time point at which the supply voltage Vc finishes decreasing to Vcl may be set as the time point of the occurrence of the instantaneous interruption.

FIG. 3 is a timing chart for illustrating an example of an image display operation of the display device 1 according to the comparative example. In FIG. 3, the image display operation corresponding to the supply voltage Vc and the input image data output from the MPU 20 is illustrated. As illustrated in FIG. 3, after the display device 1 starts up at the startup time Ts, time is required until the display device 1 becomes ready to display the input image, and hence the MPU 20 is kept from outputting the input image data to the control unit 13 until a time Td (hereinafter referred to as “image input start time Td”). Therefore, during a predetermined time period from the startup time Ts until the image input start time Td, the control unit 13 displays the pattern image on the display panel 10. Note that, during the above-mentioned predetermined time period, processing (link training) for setting conditions (transmission conditions) for transmitting the input image data to the display device 1 may be executed. In this comparative example, the control unit 13 is configured to display the pattern image on the display panel 10 a predetermined time period (hereinafter referred to as “operation preparation period Pa”) after the supply voltage Vc reaches Vch. The operation preparation period Pa is a preparation period after the operable voltage starts to be supplied until the control unit 13 is enabled to operate. That is, when the control unit 13 is enabled to operate, the control unit 13 starts to display the pattern image on the display panel 10. The control unit 13 acquires the pattern image data stored in the storage unit 15, and generates the pattern image for display based on the pattern image data to display the pattern image on the display panel 10. After the image input start time Td, the control unit 13 acquires the input image data output from the MPU 20, and generates the input image for display based on the input image data to display the input image on the display panel 10.

Further, when an instantaneous interruption occurs in the display device 1 at the instantaneous interruption occurrence time Ta, the image stops being displayed on the display panel 10. After that, when the display device 1 recovers from the instantaneous interruption at the instantaneous interruption recovery time Tb, the control unit 13 displays the pattern image on the display panel 10 the operation preparation period Pa after the supply voltage Vc reaches Vch in the same manner as at the startup time Ts. In this comparative example, the control unit 13 is caused to display the pattern image on the display panel 10 every time the display device 1 recovers from the instantaneous interruption.

In this case, in FIG. 3, the MPU 20 keeps outputting the input image data to the control unit 13 after the image input start time Td. For example, when an instantaneous interruption occurs due to a failure between the external power source 30 and the power supply circuit 14 or between the power supply circuit 14 and the control unit 13, there may occur a phenomenon that the image is not displayed on the display panel 10 because the control unit 13 is not in operation while the external display system is operating normally and the MPU 20 is outputting the input image data to the control unit 13. That is, the MPU 20 is outputting the input image data to the control unit 13 also during the instantaneous interruption period Pi, and the input image may become able to be displayed on the display panel 10 immediately after the supply voltage Vc is recovered to Vch at the instantaneous interruption recovery time Tb. In this manner, when the display device 1 recovers from the instantaneous interruption, the display device 1 becomes ready to display the input image relatively quickly, which often eliminates the need to display the pattern image. Therefore, this embodiment is configured to prevent the pattern image from being displayed on the display panel 10 every time the display device 1 recovers from the instantaneous interruption. Functions implemented by the control unit 13 according to this embodiment are described below.

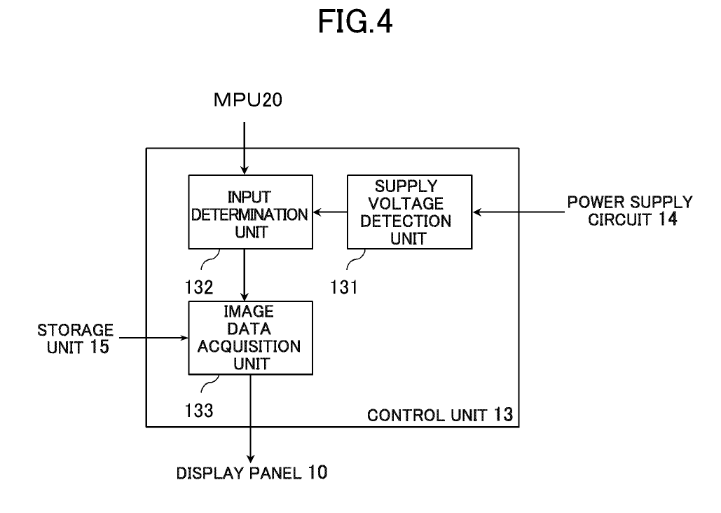

FIG. 4 is a block diagram for illustrating an example of the functions implemented by the control unit 13 according to this embodiment. As illustrated in FIG. 4, the control unit 13 according to this embodiment includes a supply voltage detection unit 131, an input determination unit 132, and an image data acquisition unit 133.

The supply voltage detection unit 131 detects the supply voltage Vc supplied from the power supply circuit 14 to the control unit 13. It suffices that the supply voltage detection unit 131 detects such a time variation of the supply voltage Vc supplied from the power supply circuit 14 to the control unit 13 as shown in FIG. 2. In this embodiment, the supply voltage detection unit 131 particularly detects that the supply voltage Vc has changed from Vcl to Vch. Further, the supply voltage detection unit 131 detects that the supply voltage Vc has reached Vch. Note that, the supply voltage detection unit 131 may detect the power supply voltage Vo supplied from the external power source 30.

When the supply voltage detection unit 131 detects that the supply voltage Vc has changed from Vcl to Vch, the input determination unit 132 determines whether or not the input image data is to be input from the MPU 20 to the control unit 13 during the predetermined time period after the supply voltage Vc has reached Vch. As shown in FIG. 2, as a timing at which the supply voltage Vc reaches Vch, there are two timings at which the display device 1 starts up (startup time Ts) and at which the display device 1 recovers from the instantaneous interruption (instantaneous interruption recovery time Tb). The input determination unit 132 can distinguish between the startup time Ts and the instantaneous interruption recovery time Tb by determining whether or not the input image data is to be input from the MPU 20 to the control unit 13. Based on the fact that time is required after the startup time Ts until the image input start time Td and that the input image data is input in a short period of time after the instantaneous interruption recovery time Tb, the timing can be distinguished as the startup time Ts when it is determined that the input image data is not to be input from the MPU 20 to the control unit 13 after the supply voltage Vc reaches Vch, and distinguished as the instantaneous interruption recovery time Tb when it is determined that the input image data is to be input from the MPU 20 to the control unit 13 after the supply voltage Vc reaches Vch.

Specifically, for example, the input determination unit 132 queries the MPU 20 of presence or absence of the input image data, and the input determination unit 132 determines whether or not the input image data is to be input based on a response relating to the presence or absence of the input image data which is transmitted from the MPU 20. Further, the input determination unit 132 may determine a plurality of times whether or not the input image data is to be input during a predetermined time period. Specifically, the input determination unit 132 may periodically query the MPU 20 of the presence or absence of the input image data during the predetermined time period. In this case, the input determination unit 132 may determine that the input image data is to be input when a number of times that the response indicating the presence of the input image data has been detected from the MPU 20 exceeds a predetermined number of times.

When the input determination unit 132 determines that the input image data is not to be input, the image data acquisition unit 133 acquires the pattern image data stored in the storage unit 15. Then, the control unit 13 displays the pattern image based on the acquired pattern image data on the display panel 10. On the other hand, when the input determination unit 132 determines that the input image data is to be input, the image data acquisition unit 133 acquires the input image data output from the MPU 20. Then, the control unit 13 displays the input image based on the acquired input image data on the display panel 10.

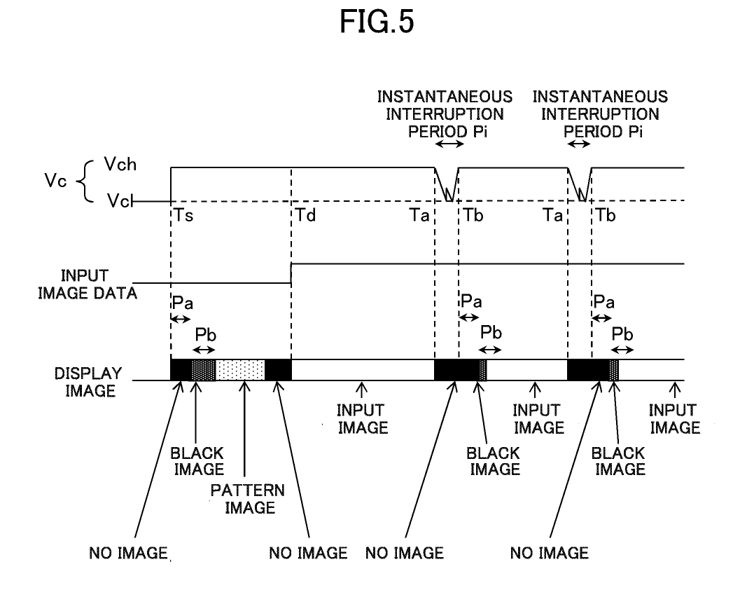

FIG. 5 is a timing chart for illustrating an example of an image display operation of the display device 1 according to this embodiment. In FIG. 5, the image display operation corresponding to the supply voltage Vc and the input image data output from the MPU 20 is illustrated. As illustrated in FIG. 5, after the display device 1 starts up at the startup time Ts, time is required until the display device 1 becomes ready to display the input image, and hence the MPU 20 is kept from outputting the input image data to the control unit 13 until the image input start time Td. Therefore, during a predetermined time period from the startup time Ts until the image input start time Td, the control unit 13 displays the pattern image on the display panel 10. In this embodiment, when the supply voltage detection unit 131 of the control unit 13 detects that the supply voltage Vc has reached Vch, the input determination unit 132 of the control unit 13 determines whether or not the input image data is to be input from the MPU 20 to the control unit 13 during a predetermined time period (hereinafter referred to as “determination period Pb”) after the operation preparation period Pa has elapsed since the startup time Ts at which the supply voltage Vc reached Vch. Note that, the input determination unit 132 may determine whether or not the input image data is to be input from the MPU 20 to the control unit 13 also during the operation preparation period Pa. In FIG. 5, the MPU 20 is not outputting the input image data to the control unit 13 during the first determination period Pb after the startup time Ts. Therefore, during the determination period Pb, the input determination unit 132 of the control unit 13 determines that the input image data is not to be input, and the image data acquisition unit 133 acquires the pattern image data stored in the storage unit 15. After the determination period Pb has elapsed, the control unit 13 displays the pattern image based on the acquired pattern image data on the display panel 10. After the image input start time Td, the control unit 13 displays the input image on the display panel 10 based on the input image data input from the MPU 20.

Further, when an instantaneous interruption occurs in the display device 1 at the instantaneous interruption occurrence time Ta, the image stops being displayed on the display panel 10. However, it is assumed that the MPU 20 keeps outputting the input image data to the control unit 13 also during the instantaneous interruption period Pi. For example, when an instantaneous interruption occurs due to a failure in the voltage supply from the external power source 30 to the power supply circuit 14 or the voltage supply from the power supply circuit 14 to the control unit 13, there occurs a phenomenon that the image is not displayed on the display panel 10 because the control unit 13 is not driven while the external display system is operating normally and the MPU 20 is outputting the input image data. In this embodiment, when the display device 1 recovers from the instantaneous interruption at the instantaneous interruption recovery time Tb, the supply voltage detection unit 131 of the control unit 13 detects that the supply voltage Vc has reached Vch. After the operation preparation period Pa has elapsed since the instantaneous interruption recovery time Tb at which the supply voltage Vc reached Vch, the input determination unit 132 of the control unit 13 determines whether or not the input image data is to be input from the MPU 20 to the control unit 13 during the determination period Pb. Note that, the input determination unit 132 may determine whether or not the input image data is to be input from the MPU 20 to the control unit 13 also during the operation preparation period Pa. In FIG. 5, the MPU 20 is outputting the input image data to the control unit 13 after the image input start time Td. Therefore, the input determination unit 132 of the control unit 13 determines that the input image data is to be input, and the image data acquisition unit 133 acquires the input image data input from the MPU 20. The control unit 13 displays the input image based on the acquired input image data on the display panel 10. When the input determination unit 132 determines that the input image data is to be input, the control unit 13 may display the input image on the display panel 10 before the determination period Pb has elapsed, or may display the input image on the display panel 10 after the determination period Pb has elapsed. In this manner, in a case where the MPU 20 is outputting the input image data when the supply voltage Vc has reached Vch, the control unit 13 displays the input image on the display panel 10 without displaying the pattern image.

In this embodiment, during the predetermined time period after the supply voltage Vc has reached Vch, it is determined whether or not the input image data is to be input from an MPU, to thereby be able to display the input image on the display panel 10 without displaying the pattern image when the display device 1 recovers from the instantaneous interruption and when there is no need to display the pattern image (when the MPU 20 is outputting the input image data). This can prevent the pattern image from being displayed unnecessarily every time the display device 1 recovers from the instantaneous interruption.

Note that, in FIG. 5, an example in which the MPU 20 keeps outputting the input image data to the control unit 13 after the image input start time Td is illustrated, but the present application is not limited to this example. For example, during the instantaneous interruption period Pi, the MPU 20 may stop outputting the input image data to the control unit 13. Even in this case, when the MPU 20 starts to output the input image data to the control unit 13 during the determination period Pb, the control unit 13 is caused to display the input image on a display panel without displaying the pattern image.

Note that, even after the instantaneous interruption recovery time Tb, when the input determination unit 132 of the control unit 13 determines that the input image data is not to be input during the determination period Pb, the image data acquisition unit 133 acquires the pattern image data stored in the storage unit 15. After the determination period Pb has elapsed, the control unit 13 displays the pattern image based on the acquired pattern image data on the display panel 10.

Further, the control unit 13 may display a black image on the display panel 10 during the determination period Pb. The control unit 13 may acquire the black image data stored in the storage unit 15, and display the black image based on the black image data on the display panel 10.

While there have been described what are at present considered to be certain embodiments of the application, it will be understood that various modifications may be made thereto, and it is intended that the appended claims cover all such modifications as fall within the true spirit and scope of the invention.

What is claimed is:

1. A display device, comprising:
a display panel configured to display an image;
a control unit configured to control the display panel based on input image data input from outside; and
a storage unit configured to store predetermined pattern image data, wherein:
the control unit comprises a determination unit configured to determine whether or not the input image data is to be input during a predetermined time period after a supply voltage from a power source has reached a predetermined value; and
the control unit is further configured to display a pattern image based on the predetermined pattern image data on the display panel after the predetermined time period has elapsed when the determination unit determines that the input image data is not to be input, and display an input image based on the input image data on the display panel when the determination unit determines that the input image data is to be input.

2. The display device according to claim 1, wherein:
the storage unit is further configured to store black image data; and
the control unit is further configured to display a black image based on the black image data on the display panel during the predetermined time period.

3. The display device according to claim 1, wherein the determination unit is further configured to:
determine a plurality of times whether or not the input image data has been input during the predetermined time period; and
display the input image based on the input image data on the display panel when a number of times that an input of the input image data has been detected exceeds a predetermined number of times.
